(19) United States
(12) Patent Application Publication
(10) Pub. No.: US 2026/0212535 A1
(43) Pub. Date: Jul. 23, 2026

(54) HUMAN BODY VIDEO CODING, DECODING, AND COMMUNICATION METHOD, AND MODEL OPTIMIZATION METHOD

(71) Applicant: Alibaba Damo (Hangzhou) Technology Co., Ltd., Hangzhou (CN)

(72) Inventors: Bolin CHEN, Kowloon Tong (HK); Yan YE, San Diego, CA (US)

(21) Appl. No.: 19/447,990

(22) Filed: Jan. 13, 2026

(30) Foreign Application Priority Data
Jan. 21, 2025 (CN) 202510107799.2

(51) Int. Cl. G06T 9/00; G06T 3/18; G06T 13/40; G06T 17/20; H04N 19/124; H04N 19/13; H04N 19/503

(52) U.S. Cl. CPC G06T 9/001; G06T 3/18; G06T 13/40; G06T 17/20; H04N 19/13; H04N 19/503; H04N 19/124

(57) ABSTRACT

This application provides a human body video coding, decoding, and communication method, and a model optimization method. The human body video coding method includes: inputting a frame in a to-be-coded human body video into a pre-trained 3D human body model OSX, to obtain a first human body semantic set, where the first human body semantic set is used for simplifying description of a human body signal; determining a second human body semantic set from the first human body semantic set, where the second human body semantic set is used for describing a motion-related signal in the human body signal, to interact with the human body signal at a decoder side by configuring a value of a human body semantic in the second human body semantic set; compressing the second human body semantic set to obtain a first coded bit stream, and compressing a key reference frame in the to-be-coded human body video to obtain a second coded bit stream; and determining the first coded bit stream and the second coded bit stream as a target coding result of the to-be-coded human body video. Compact and configurable human body semantics are used to code human body signals, thereby improving compression efficiency and enhancing interactivity.

### BACKGROUND

### Technical Field

This application relates to the field of video technologies, and in particular, to a human body video coding, decoding, and communication method, and a model optimization method.

### Description of the Related Art

In recent years, with the arrival of the “short video era”, explosive increase has appeared in human-oriented media content. This not only changes information obtaining and entertainment manners, but also brings brand new technical challenges and opportunities. Although various advances have been made in improving compression and storage efficiency of human body video content, compression efficiency of a coded bit stream still remains to be improved. In addition, a current compressed bit stream does not support interaction with an original human body signal, limiting an interaction function of video communication. In view of the technical problem, no effective solution has been provided in the related technology.

### BRIEF SUMMARY

Embodiments of this application provide a human body video coding, decoding, and communication method, and a model optimization method, to resolve the foregoing one or more technical problems.

According to a first aspect, an embodiment of this application provides a human body video coding method, including: inputting a frame in a to-be-coded human body video into a pre-trained 3D human body model OSX, to obtain a first human body semantic set, where the first human body semantic set is used for simplifying description of a human body signal in the to-be-coded human body video; determining a second human body semantic set from the first human body semantic set, where the second human body semantic set is used for describing a motion-related signal in the human body signal, to interact with the human body signal at a decoder side by configuring a value of a human body semantic in the second human body semantic set; compressing the second human body semantic set to obtain a first coded bit stream, and compressing a key reference frame in the to-be-coded human body video to obtain a second coded bit stream; and determining the first coded bit stream and the second coded bit stream as a target coding result of the to-be-coded human body video.

According to a second aspect, an embodiment of this application provides a human body video decoding method, including: after a first coded bit stream and a second coded bit stream that are determined by using the foregoing human body video coding method are received, performing decoding and reconstruction based on the first coded bit stream to obtain a second human body semantic set, and performing decoding and reconstruction based on the second coded bit stream to obtain a key reference frame; inputting the key reference frame into a pre-trained 3D human body model OSX, and obtaining a third human body semantic set other than the second human body semantic set in a first human body semantic set by using a parameter extraction module of the 3D human body model OSX; inputting the second human body semantic set and the third human body semantic set into a decoder of the 3D human body model OSX to reconstruct a 3D human body mesh of a subsequent frame in a to-be-coded human body video, and inputting the key reference frame into the decoder to reconstruct a 3D human body mesh of the key reference frame; performing motion estimation on the 3D human body mesh of the subsequent frame and the 3D human body mesh of the key reference frame; and generating a human body video based on the key reference frame and a motion estimation result.

According to a third aspect, an embodiment of this application provides a human body video communication method, including: after a first coded bit stream and a second coded bit stream that are determined by using the foregoing human body video coding method are received, performing decoding and reconstruction based on the first coded bit stream to obtain a second human body semantic set, and performing decoding and reconstruction based on the second coded bit stream to obtain a key reference frame; inputting the key reference frame into a pre-trained 3D human body model OSX, and obtaining a third human body semantic set other than the second human body semantic set in a first human body semantic set by using a parameter extraction module of the 3D human body model OSX; modifying a value of a human body semantic in the second human body semantic set and/or a value of a human body semantic in the third human body semantic set based on user-personalized communication requirements, to obtain a reconfigured second human body semantic set and a reconfigured third semantic set; and generating a changed human body video by using the foregoing human body video decoding method.

According to a fourth aspect, an embodiment of this application provides a model optimization method, where the model is disposed at a decoder side, the model includes a first network and a second network, the first network and the second network are respectively used for implementing motion estimation and human body video generation in the foregoing human body video decoding method, and the method includes: jointly training the first network and the second network by using an end-to-end strategy.

According to a fifth aspect, an embodiment of this application provides an electronic device, including a memory, a processor, and a computer program stored on the memory, where the processor implements the method according to any one of the foregoing when executing the computer program.

According to a sixth aspect, an embodiment of this application provides a computer-readable storage medium, where the computer-readable storage medium stores a computer program, and the computer program, when executed by a processor, implements the method according to any one of the foregoing.

According to a seventh aspect, an embodiment of this application provides a computer program product, including computer instructions. When the computer instructions are executed by a processor, the method according to any one of the foregoing is implemented.

Compared with the related technology, this application has the following advantages:

A human body signal is represented by using a human body semantic outputted by a pre-trained 3D human body model OSX, and the outputted human body semantic is optimized, to generate a compact human body semantic. In addition, because the compact human body semantic has a clear physical meaning and is configurable at a decoder side, a finally generated compact and configurable human body semantic codes the human body signal, which improves compression efficiency and enhances interactivity, thereby resolving technical problems such as that compression efficiency of a coded bit stream in the related technology is to be improved, and an interaction function of video communication is limited because a current compressed bit stream does not support interaction with an original human body signal.

Semantic hierarchy representations are provided in the coded bit stream, and these semantically meaningful representations are explicitly evolved into high-dimensional mesh representations with the help of the 3D human body model, thereby promoting dynamic perception, and further improving quality of a decoded video that needs to be reconstructed.

Reconstruction of a 3D human body mesh may be flexibly edited by modifying different semantic hierarchy representations, so that a head pose and a body pose of the 3D mesh are changed to implement a personalized representation, thereby implementing interactive human body video communication.

A first network and a second network are jointly trained by using an end-to-end strategy, so that a trained first network may improve efficiency of mesh-based dense motion estimation, thereby promoting dynamic perception. A trained second network may improve generation efficiency of a human body frame, thereby improving quality of a decoded video.

The foregoing description is merely an overview of technical solutions of this application. To understand the technical solutions of this application more clearly, implementation can be performed according to content of the specification. Moreover, to make the foregoing and other objectives, features, and advantages of this application more comprehensible, specific implementations of this application are described below.

### BRIEF DESCRIPTION OF THE SEVERAL VIEWS OF THE DRAWINGS

In the accompanying drawings, unless otherwise specified, same reference signs throughout a plurality of accompanying drawings represent same or similar components or elements. These accompanying drawings are not necessarily drawn to scale. It should be understood that these accompanying drawings only show some implementations according to this application, and should not be construed as a limitation to the scope of this application.

FIG. 1 is a schematic diagram of a video compression framework following a prediction-transform architecture in the related technology according to an embodiment of this application;

FIG. 2 is a schematic diagram of a basic framework of an end-to-end video compression deep model in the related technology according to an embodiment of this application;

FIG. 3 is a schematic diagram of a basic framework of a deep learning video generation compression solution based on a first order motion model in the related technology according to an embodiment of this application;

FIG. 4 is a schematic diagram of a basic framework of a deep learning video generation compression solution based on compact feature representation in the related technology according to an embodiment of this application;

FIG. 5 is a schematic flowchart of a human body video coding method according to an embodiment of this application;

FIG. 6 is a structural block diagram of a human body video coding apparatus according to an embodiment of this application;

FIG. 7 is a schematic flowchart of a human body video decoding method according to an embodiment of this application;

FIG. 8 is a structural block diagram of a human body video decoding apparatus according to an embodiment of this application;

FIG. 9 is a schematic flowchart of a human body video communication method according to an embodiment of this application;

FIG. 10 is a structural block diagram of a human body video communication apparatus according to an embodiment of this application;

FIG. 11 is a schematic flowchart of a model optimization method according to an embodiment of this application;

FIG. 12 is a structural block diagram of a model optimization apparatus according to an embodiment of this application;

FIG. 13 is a structural block diagram of an IHVC framework according to an embodiment of this application; and

FIG. 14 is a block diagram of an electronic device used to implement embodiments of this application.

### DETAILED DESCRIPTION

Only some example embodiments are briefly described below. As a person skilled in the art can realize, the described embodiments may be modified in various different manners without departing from the idea or the scope of this application. Therefore, the accompanying drawings and descriptions are essentially considered to be examples only rather than limiting the scope of the specification.

For ease of understanding the technical solutions of embodiments of this application, related technologies of the embodiments of this application are described below. The following related technologies, as additional or alternative solutions, may be combined in various ways with the described technical solutions of the embodiments of this application, and all fall within the protection scope of the embodiments of this application.

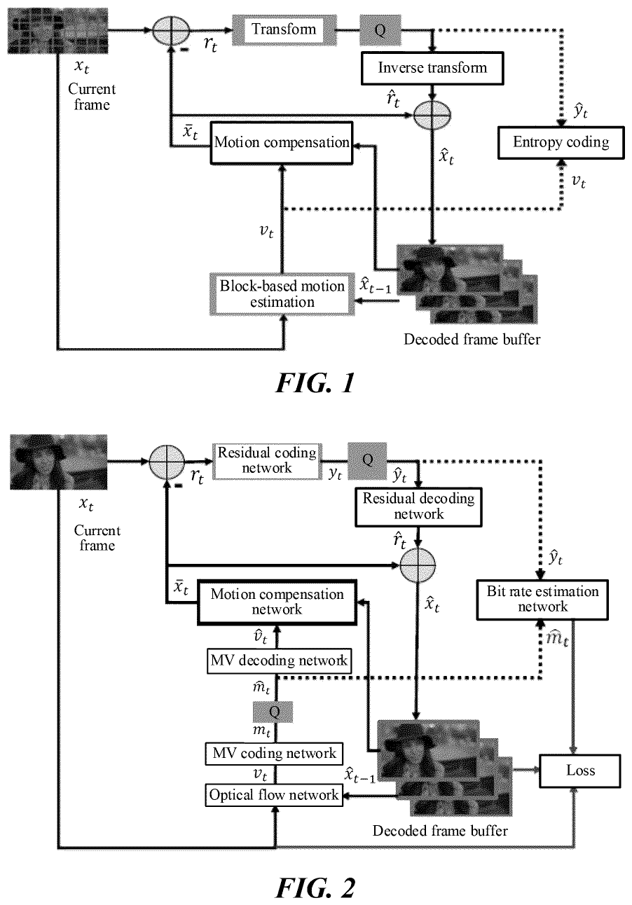

Some related technology includes various video compression standards, such as advanced video coding (Advanced Video Coding, AVC), high efficiency video coding (High Efficiency Video Coding, HEVC), and versatile video coding (Versatile Video Coding, VVC), which have been highly developed and achieved good compression performance. These standards utilize a block-based hybrid video coding framework, to exploit space redundancy, time redundancy, and information entropy redundancy in a video. In this framework, a video compression coder generates a bit stream based on an inputted current frame, and a decoder reconstructs a video frame based on a received bit stream. A classic video compression framework shown in FIG. 1 follows a prediction-transform architecture. For example, an input frame xₜ is divided into a series of blocks having a same size, e.g., square regions (for example, blocks of 8×8 pixels). A coding process of an example video compression algorithm at a coder side mainly includes the following steps: Step 1. Motion estimation: A motion between a current frame xₜ and a previous reconstructed frame \hat{x}ₜ₋₁ is estimated, to obtain a motion vector vₜ corresponding to each block. Step 2. Motion compensation: Based on the motion vector vₜ defined in step 1, a corresponding pixel in the previous reconstructed frame is copied to the current frame, to obtain a predicted frame x̅ₜ. Then, a residual rₜ between the original frame xₜ and the predicted frame x̅ₜ is calculated, e.g., rₜ=zₜ−x̅ₜ. Step 3. Transform and quantization: The residual rₜ obtained in step 2 is quantized into ŷₜ. Linear transformation (for example, discrete cosine transform (Discrete Cosine Transform, DCT)) is used before quantization, to obtain better compression performance. Step 4. Inverse transform: The quantization result ŷₜ in step 3 is used to perform inverse transform to obtain a reconstructed residual t. Step 5. Entropy coding: The motion vector vₜ in step 1 and the quantization result ŷₜ in step 3 are coded into a bit stream by using an entropy coding method and sent to a decoder. Step 6. Frame reconstruction: A reconstructed frame x̅ₜ is obtained by adding the predicted frame x̅ₜ in step 2 and the reconstructed residual \hat{r}ₜ in step 4, e.g., \hat{x}ₜ=\hat{r}ₜ+x̅ₜ. The reconstructed frame is used for motion estimation of a (t+1)^{th} frame in step 1. For the decoder, based on a bit stream provided by the coder in step 5, motion compensation in step 2 and inverse quantization in step 4 are performed, and then frame reconstruction in step 6 is performed, to obtain a reconstructed frame \hat{x}ₜ.

With the rapid development of deep learning, many deep learning-based algorithms are introduced to replace or enhance video coding tools. For joint optimization of an entire image/video compression framework, rather than designing a specific module, an end-to-end image/video compression algorithm emerges. For example, an end-to-end video coding solution is DVC, and this solution jointly optimizes all components of video compression. In addition, problems of content adaptation and perception of error propagation are considered, and an online coder update solution is developed to improve video compression performance. However, these learning-based methods are aimed at a general natural scene, and human content such as a face, a body, or another part is not specifically considered. FIG. 2 shows a basic framework of a first end-to-end video compression deep model. The model jointly optimizes all components of video compression, such as motion estimation, motion compression, and residual compression. For example, motion information is obtained through learning-based optical flow estimation and a current frame is reconstructed, and then two neural networks of an autocoder style are used to compress corresponding motion and residual information. All modules learn together by using a single loss function. The modules cooperate with each other to balance reduction of a quantity of compressed bits and improvement of decoded video quality. There is a one-to-one correspondence between the end-to-end deep framework shown in FIG. 2 and the video compression framework shown in FIG. 1. These relationships and differences thereof are briefly summarized as follows: Step 1. Motion estimation and compression: An optical flow, regarded as motion information vₜ, is estimated by using a convolutional neural network (Convolutional Neural Network, CNN) model. An original optical flow value is not directly coded, but a motion vector (Motion Vector, MV) coder-decoder network is used to compress and decode the optical flow value, where a quantized motion representation is denoted as \hat{m}ₜ. Then, corresponding reconstructed motion information \hat{r}ₜ may be obtained through decoding by using an MV decoder network. Step 2. Motion compensation: A motion compensation network is designed to obtain a predicted frame x̅ₜ based on the optical flow obtained in step 1. Step 3. Transform, quantization, and inverse transform: A highly non-linear residual coder-decoder network is used to replace linear transformation. A residual \hat{r}ₜ is non-linearly mapped to a representation yₜ, and then yₜ is quantized into ŷₜ. To construct an end-to-end training solution, a quantization method is used. The quantized representation ŷₜ is sent to a residual decoder network, to obtain a reconstructed residual \hat{r}ₜ. Step 4. Entropy coding: In a testing stage, the quantized motion representation \hat{m}ₜ in step 1 and the residual representation ŷₜ in step 3 are coded into bits and sent to a decoder. In a training stage, to estimate a bit quantity cost, a CNN is used to obtain a probability distribution of each symbol in \hat{m}ₜ and ŷₜ. Step 5. Frame reconstruction: The frame reconstruction can be achieved in any existing or future developed approaches, which are all included in the scope of the disclosure, details of which are not needed for the appreciation of the present specification and are not described herein.

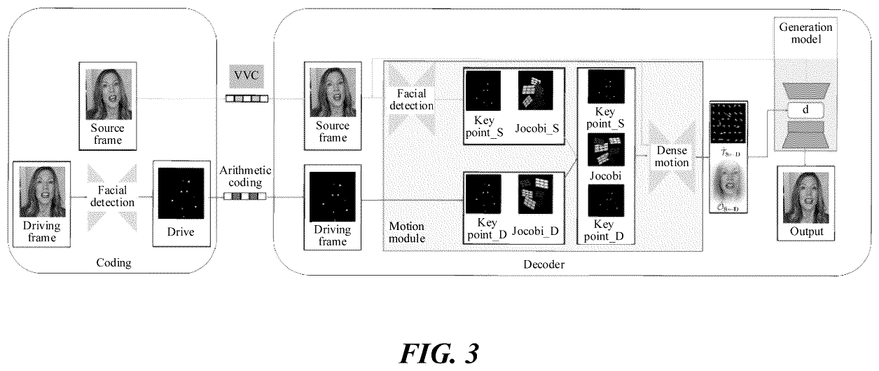

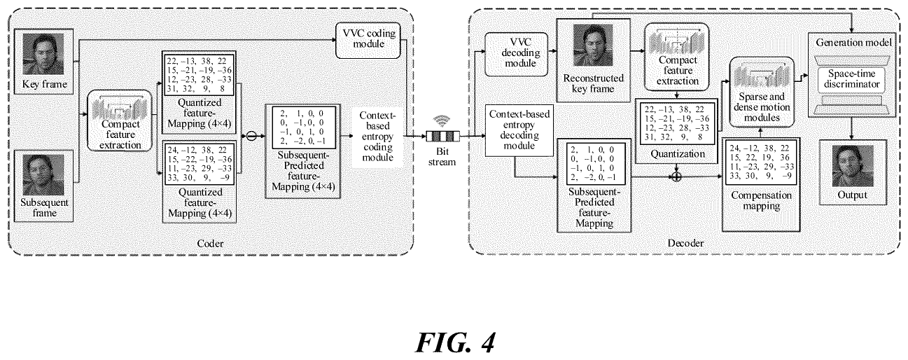

Another related technology before this application is that: With the emergence of deep generative models, especially a generative adversarial network (Generative Adversarial Network, GAN), face video compression achieves significant performance improvement. In a video-to-video synthesis task, a novel solution Face-video to video is proposed. The solution uses a compact three-dimensional key point representation to drive a generative model to render a target frame. In addition, VSBNet is further proposed in a technology, and an original frame is reconstructed from a landmark point by using adversarial learning. In addition, a compact feature transformation and embedding (Compact Feature Transformation and Embedding, CFTE)-based end-to-end talking-head video compression framework is further proposed in a technology. The framework is exquisitely designed to implement efficient face video compression, and is applicable to an ultra-low bandwidth scenario. The CFTE solution uses compact feature representation to compensate time evolution and reconstruct a target face video frame in an end-to-end manner. In addition, the CFTE solution may be combined into a video coding framework with rate-distortion target supervision. Although these algorithms have achieved, by using a strong rendering capability of a deep generative model, that a frame can be reconstructed based on only a few face parameters, some head poses and motions of facial expressions still cannot be accurately rendered compared to an original dynamic video. FIG. 3 shows a basic framework of a deep learning video generation compression solution based on a first order motion model. Additionally, a technology proposes a first order motion model (First Order Motion Model, FOMM) that deforms a reference source frame to follow a motion in a driving video. The method uses a coder-decoder architecture and combines a motion transmission component: Step 1. A key point extractor is learned by using an equivariant loss without an explicit label. By using the key point extractor, two sets containing ten learned key points are calculated for a source frame and a driving frame. The learned key points are converted from a feature map having a size of 64×64 channels by using a Gaussian mapping function, and each corresponding key point may represent feature information of different channels. It should be noted that, each key point is a point of (x, y) and may represent the most important information in the feature map. Step 2. A dense motion network generates a dense motion field and an occlusion map by using the key points and the source frame. Step 3. A coder codes the source frame by using any image/video compression method (such as high efficiency video coding (High Efficiency Video Coding, HEVC)/VVC or joint photographic experts group (Joint Photographic Experts Group, JPEG)/BPG). Herein, the source frame is compressed by using the VVC. Step 4. The generated feature map is warped by using the dense motion field (through a differentiable mesh sampling operation), and then a warped feature map is multiplied by the occlusion map. A decoder generates an image from the warped map.

A basic framework of another deep learning video generation compression solution based on compact feature representation is shown in FIG. 4. The solution follows a coder-decoder architecture. At a coder side, a compression framework includes three modules: a coder configured to compress a key frame, a feature extractor configured to extract a compact human feature of another intermediate frame, and a feature coding module configured to compress an inter prediction residual of a compact human feature. First, a key frame representing a human texture is compressed by using a VVC coder. By using a compact feature extractor, each subsequent intermediate frame is represented by using a compact feature matrix having a size of 1×4×4. It should be noted that, a size of the compact feature matrix is not fixed, and a quantity of feature parameters may be increased or decreased based on specific requirements on bit rate consumption. Subsequently, inter prediction and quantization are performed on these extracted features, and finally entropy coding is performed on a residual, to generate a final bit stream. At a decoder side, the compression framework further includes three main modules, including a decoding module configured to reconstruct a key frame, a module configured to reconstruct a compact feature through entropy decoding and compensation, and a module configured to generate a final video by using the reconstructed feature and the decoded key frame. More for example, in a process of generating the final video, a key frame decoded from a VVC bit stream may be further represented in a form of features through compact feature extraction. Subsequently, a related sparse motion field is calculated based on features of the key frame and the intermediate frame, to generate a pixel-level dense motion map and an occlusion map. Finally, a final video having an accurate appearance, pose, and expression is generated based on the deep generative model and by using the decoded key frame, the pixel-level dense motion map, and an occlusion map represented by an implicit motion field.

Although the foregoing learning-based end-to-end video compression methods in the related technology can achieve efficient compression performance in a moving human body video, there are some defects in directly applying a common compression algorithm to a human body video compression system with an ultra-low bit rate and enhanced interactivity.

1. In a compression algorithm, each video frame is compressed by using block-based motion estimation, discrete cosine transform (DCT), and the like. Therefore, it is still difficult to further reduce coding bits. As a result, this type of algorithm is not applicable to a human body video compression scenario with an ultra-low bit rate.

2. These learning-based end-to-end video compression methods focus on a general natural scenario without specifically considering human body motion information. In particular, a feature extracted from a moving human body is described by using a feature structure change with a strong prior, for example, a key point or a skeleton, which can greatly help reconstruct a higher-quality video.

3. Although these generation compression algorithms (such as FOMM or Face-video to video) implement frame reconstruction using a few parameters through a powerful rendering capability of the deep generative model, some human body pose motions still cannot be accurately rendered compared to the moving human body video. In other words, most algorithms based on 2D face representation (e.g., 2D landmarks and 2D key points) have poor performance in terms of photorealism, or cannot resolve a problem of identity reservation, or cannot completely transfer a driving pose.

4. For these existing 2D generation compression algorithms, semantic information cannot be included in a compressed code stream to control a human body motion pose. This obvious defect greatly limits the application of digital human communication in the metaverse.

Implementations of the present specification includes an IHVC framework, which can realize low-bandwidth and enhanced-interactivity human body video communication. For example, at the encoder side, the key-reference frame, which, for example, represents the human body textures, is compressed with the VVC (Versatile Video Coding) codec, which provides texture reference for signal synthesis. The subsequent inter frames of the human body video are fed into a neural network-based parameter regressor for the characterization of compact and interactive semantics (e.g., 21-dim human pose parameters, 3-dim human translation parameters, 3-dim human rotation parameters and 4-dim human location parameters). Herein, the specific dimensions of these semantic parameters are just some examples, and they can be determined variously according to the bandwidth condition or other application scenarios. These disentangled human semantics are further inter-predicted, quantized and entropy-coded into a transmittable bitstream.

When receiving the bitstreams, a decoder will perform the mesh editing, reconstruction, and signal synthesis towards, e.g., personalized interactions. First, the bitstream of the compressed key-reference frame is decoded via the VVC codec, and further projected into some 3D human semantics. Besides, the compact semantics of inter frames, which are different from the 3D human semantics obtained from the key-reference frame, are obtained by entropy decoding and compensation. Subsequently, the corresponding semantics of the key-reference frame and the inter frame are input into a 3D human template to reconstruct human body meshes, yielding the generation of the pixel-wise dense motion fields (e.g., dense flow and occlusion map). In some implementations, the reconstruction of 3D human body meshes can be flexibly edited by modifying different semantic-level representations, such that, e.g., the head-pose and body-pose of 3D meshes can be varied towards personalized characterization. Finally, given the decoded key-reference frame and pixel-wise dense motion fields, the human body video can be reconstructed based on the strong inference capability of deep generative models.

The IHVC framework enjoys several desired advantages, including the compact representations for ultra-low bitrate and semantically meaningful representations for enhanced interactivity. First, the implementations take advantage of the knowledge of human body signals, such that the simplified 40-dimension semantic parameters are used to characterize the nonlinear dynamics and complex motion of human body signals, thus facilitating the ultra-low bitrate human-oriented video communication. In addition, these disentangled representations are interpretable with distinct semantic meanings in terms of, e.g., body posture, head posture and camera location, which can be independently controllable for immersive interactivity and personalized reconstruction.

The input high-dimensional human body signal can be compactly characterized with semantic information and be reconstructed into the corresponding human mesh. For example, a pretrained 3D human model can be used as the baseline module and its parametrization or modelling processes can be enhanced for interactive compression functionalities.

Semantic-level parameter regression and encoding can be implemented. For example, each input frame, e.g., the VVC reconstructed key-reference frame or subsequent inter frames, is fed into the 3D human model, thus obtaining a series of regressed semantic representations in terms of 3D separate body joint, body shape, global translation, 3D global rotation, and a bounding box for body location. In total, the number of these regressed semantic parameters for each human body signal is 83, resulting in relatively high representation costs.

The regressed semantic parameters is simplified. First, it is assumed that the human body frames from the same sequence share the matched human body shape, so these shape coefficients is directly sourced from the reconstructed key-reference frame without signaling. In addition, only the last 7 joints are used to represent head posture and hand motions. Therefore, the last 42 dimensions from the 63-dimension vector are signaled as posture motion coefficients, and the remaining first 42-dimension parameters can be obtained from the reconstructed key-reference frame. As for other semantics related with translation, rotation and location, they can be retained due to their compact representation and interactive function. To conclude, in the final transmitted compact semantics, the total dimensions of for each human body signal are 40. In addition, the inter-prediction operation between the current-frame semantics and the previously-reconstructed-frame semantics is further performed, and then the context-based arithmetic coding is applied to output the final bitstream.

When the decoder receives the semantics bitstream, the semantic coefficients of inter frames can be reconstructed via the entropy decoding, inverse quantization and semantics compensation operations. Afterwards, these decoded semantic coefficients and other semantic parameters (e.g., the first 42 dimension parameters) regressed from the reconstructed key-reference frame will be jointly encapsulated and fed into the decoder of the human body model to reconstruct 3D human mesh of inter frames.

As for the 3D human mesh of the reconstructed key-reference frame, it can be directly generated via the human body model without any parameter optimization. In some implementations, these 3D meshes can be further transformed to 2D mesh images for motion estimation.

A mesh-based motion estimation scheme can evolve these transformed high-dimensional meshes into pixel-wise dense motion fields. In some implementations, the Spatially-Adaptive Normalization (SPADE) mechanism is employed as the backbone network to predict these motion fields. Hence, the dense motion flow and occlusion map can be obtained as the guidance of signal reconstruction.

The strong inference capability of deep generative networks can well facilitate the realistic signal reconstruction within the generative compression paradigm. In some implementations, the GAN architecture is employed. For example, a feature warping strategy is performed to warp the decoded key-reference frame with the dense motion flow in feature-level domain. Afterwards, the occlusion map is used to indicate feature map regions with the corresponding confidences. Finally, the generation results are further fed into a discriminator module to approximate the distribution of the original signal.

In some implementations, end-to-end strategy is used to jointly train the mesh-based dense motion estimation and GAN-based human frame generation modules, where the training losses are perceptual loss and adversarial loss.

In some implementations, the IHVC framework can control body movements in the compressed code stream, which can further be applied into ultra-low bandwidth and enhanced-interactivity human communication. Thanks to disentangled parameters, with change to the value of, e.g., angle and translation, the pseudo driving human body mesh can be retargeted. Finally, the retargeted pseudo driving human body mesh is used together with key-frame mesh for motion estimation and frame generation to reconstruct face image with a novel pose and position, reflecting the adjusted parameters.

The generative compression framework allows human body signals to be effectively encoded with ultra-compact and configurable human semantics. In this manner, the bitstream featured with these interactive human semantics can be feasibly manipulated, such that, e.g., the head-pose and body-pose motions of human signal can be reconstructed towards personalized communication at the decoder side. Moreover, the mesh-based motion estimation scheme can explicitly evolve these semantically meaningful representations into high-dimensional mesh representations with the assistance of 3D human model, thus facilitating dynamics awareness and quality improvement for reconstructing the decoded video.

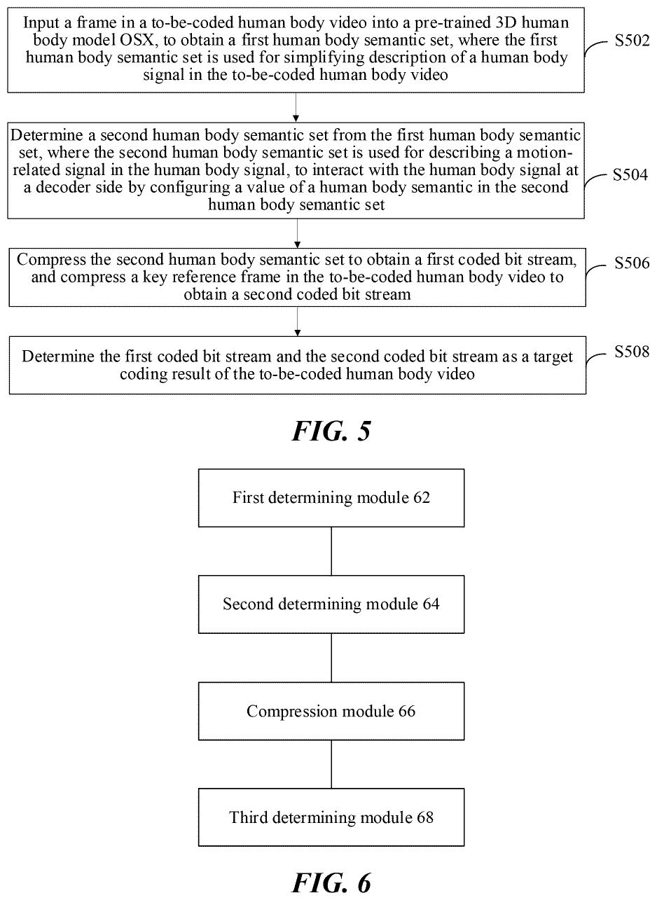

The embodiments of this application provide a human body video coding solution, which, among others, fully or partially resolve the foregoing technical problems. An application scenario of the method may be human communication (for example, medical treatment and health, education and training, movie and television entertainment, security and surveillance, and traffic and autonomous driving) with an ultra-low bandwidth and enhanced interactivity in the metaverse, a virtual uploader of live streaming e-commerce, and the like. In other words, if related technologies such as compression, coding, and storage of human body videos are involved, the human body video coding method provided in the embodiments of this application may be applied. As shown in FIG. 5, the human body video coding method may include the following steps.

S502. Input a frame in a to-be-coded human body video into a pre-trained 3D human body model OSX, to obtain a first human body semantic set, where the first human body semantic set is used for simplifying description of a human body signal in the to-be-coded human body video.

It should be noted that, the human body video is mainly a video type that focuses on capturing, recording, and analyzing a human body action and appearance. The frames in the to-be-coded human body video may include a reference key frame and a subsequent frame.

The 3D human body model is a digital human body simulation, and uses a three-dimensional coordinate system to construct a virtual human body with a sense of reality by using geometric shapes such as a polygon and a curved surface. Based on this, in this embodiment of this application, a high-dimensional human body signal may be concisely represented by human body semantic information by using the pre-trained 3D human body model OSX. For example, the first human body semantic set may be a 3D independent body joint δ_{body∈}R^{21×3} (e.g., locations of 21 key joints in 3D space), a body shape δ_{shape∈}R¹⁰, 3D global translation δ_{trans∈}R³, 3D global rotation δ_{rot∈}R³, a positioning boundary box δ_{loc∈}R³, and the like. Compared with representation in the related technology, the embodiments of this application provide clear human body semantics, which can further implement interactive compression.

To improve compression efficiency through more economic representation, the embodiments of this application further provide S504. In step S504, a second human body semantic set is determined from the first human body semantic set, where the second human body semantic set is used for describing a motion-related signal in the human body signal, to interact with the human body signal at a decoder side by configuring a value of a human body semantic in the second human body semantic set.

In some implementations, the human body semantics in the second human body semantic set are highly decoupled human body semantics, and configuring one of the human body semantics does not affect values of other human body semantics. The human body semantics in the second human body semantic set include at least the following human body semantics: a human body pose parameter, a human body translation parameter, a human body rotation parameter, a human body location parameter, and the like. The human body semantic may be multi-dimensional, and dimensions of different human body semantics may be determined by using a transmission bandwidth, reconstructed video quality, and the like.

For example, a total dimension of the second human body semantic set may be 40. The human body pose parameter may be 21-dimensional, the human body translation parameter may be 3-dimensional, the human body rotation parameter may be 3-dimensional, and the human body location parameter may be 4-dimensional.

S506. Compress the second human body semantic set to obtain a first coded bit stream, and compress a key reference frame in the to-be-coded human body video to obtain a second coded bit stream.

In some implementations, in the embodiments of this application, compressing the second human body semantic set to obtain the first coded bit stream may include operations such as inter prediction, quantization, and entropy coding on the second human body semantic set to obtain the first coded bit stream. A manner of compressing the key reference frame in the to-be-coded human body video to obtain the second coded bit stream may include inputting the key reference frame in the to-be-coded human body video into a VVC codec for compression, to further provide texture reference for signal synthesis.

S508. Determine the first coded bit stream and the second coded bit stream as a target coding result of the to-be-coded human body video.

Through the foregoing step S502 to step S508, the frame in the to-be-coded human body video is inputted into the pre-trained 3D human body model OSX, to obtain the first human body semantic set, where the first human body semantic set is used for simplifying the description of the human body signal in the to-be-coded human body video; the second human body semantic set is determined from the first human body semantic set, where the second human body semantic set is used for describing the motion-related signal in the human body signal, to interact with the human body signal at the decoder side by configuring the value of the human body semantic in the second human body semantic set; the second human body semantic set is compressed to obtain the first coded bit stream, and the key reference frame in the to-be-coded human body video is compressed to obtain the second coded bit stream; and the first coded bit stream and the second coded bit stream are determined as the target coding result of the to-be-coded human body video. In other words, in the embodiments of this application, the human body signal is represented by using the human body semantic outputted by the pre-trained 3D human body model OSX, and the outputted human body semantic is optimized, to generate a compact human body semantic. In addition, because the compact human body semantic has a clear physical meaning and is configurable at the decoder side, a finally generated compact and configurable human body semantic codes the human body signal, which improves compression efficiency and enhances interactivity, thereby resolving technical problems such as that compression efficiency of a coded bit stream in the related technology is to be improved, and an interaction function of video communication is limited because a current compressed bit stream does not support interaction with an original human body signal.

Assuming that human body frames of a same sequence (e.g., a series of consecutive image frames from a same video clip) share a matching shape δₛₕₐₚₑ. Therefore, these shape coefficients may be directly extracted from the reconstructed key reference frame without a separate signal transmission. In addition, by analyzing a physical meaning of independent body joints δₛₕₐₚₑ, it can be found that only the last 7 joints are related to head poses and hand movements. Therefore, the last 42 dimensions in a 63-dimensional vector are used as pose action coefficients δ_{body∈}R^{10×3} for signal transmission, and the remaining first 42-dimensional parameters may be obtained from the reconstructed key reference frame. Other human body semantics related to translation, rotation, and positioning may be reserved due to compact representation and interaction functions of the human body semantics. Therefore, the embodiments of this application provide that S504 may include the following steps. S5401. Determine a human body signal shared by the human body frames of the same sequence and a human body semantic corresponding to the shared human body signal in the first human body semantic set, to obtain a first target human body semantic. S5402. Determine a human body semantic unrelated to motion in the first human body semantic set, to obtain a second target human body semantic. S5403. Filter out the first target human body semantic and the second target human body semantic from the first human body semantic set, to obtain the second human body semantic set. In other words, the first human body semantic set is further optimized, to select a compact and interactive human body semantic from the first human body semantic set.

For example, it is assumed that the first human body semantic set includes: 3D independent body joints δ_{body∈}R^{21×3}, a body shape δ_{shape∈}R¹⁰, 3D global translation δ_{rot∈}R³, 3D global rotation δ_{rot∈}R³, and a positioning bounding box δ_{loc∈}R³. Because the body shape δ_{shape∈}R¹⁰ is the human body semantic corresponding to the shared human body signal, the body shape δ_{shape∈}R¹⁰ may be determined as the first target human body semantic. In the 3D independent body joints δ_{body∈}R^{21×3}, only human body semantics δₚₒₛₑ related to head poses and hand movements are determined as the second target human body semantics. Then, a final transmitted second human body semantic set is δₛₑₘ={δₚₒₛₑ,δₜᵣₐₙₛ,δᵣₒₜ,δ_{loc}}.

To implement high-efficiency compression of the second human body semantic set, the embodiments of this application further provide that S506 may include the following steps. S5601. Perform inter prediction between a human body semantic of a current frame and a human body semantic of a previously reconstructed frame, to obtain a residual generated by the inter prediction. S5602. Compress, based on context-based arithmetic coding, the residual generated by inter prediction, to obtain the first coded bit stream.

It should be noted that, the context arithmetic coding combines arithmetic coding and a context model compression method. The arithmetic coding is a lossless data compression algorithm that implements compression by coding an entire data stream into a single real number. The context model predicts a probability that a current symbol appears by analyzing a context of each symbol (e.g., symbols before and after the symbol) in data.

For example, it is assumed that a current frame is that a person is in front of a background and a left arm is put down, a human body semantic 1 (for example, coordinates of the left arm) is extracted, a previously reconstructed frame is that the person starts to lift the left arm, and a human body semantic 2 (for example, new coordinates of the left arm) is extracted. Inter prediction may be performed on the human body semantic 1 and the human body semantic 2, to obtain a residual generated by the inter prediction, and then the residual generated by the inter prediction is compressed based on the context-based arithmetic coding, to significantly reduce bandwidth requirements for storage and transmission while video quality is ensured.

It should be noted that, all user information (including but not limited to user equipment information, user personal information, and the like) and data (including but not limited to data for analysis, stored data, displayed data, and the like) involved in this application are authorized by users or fully authorized by each party. In addition, collection, use, and processing of related data need to comply with relevant laws, regulations, and standards of relevant countries and regions, and corresponding operation portals are provided for the users to choose to authorize or refuse.

The following describes the technical solutions of this application and how to resolve the foregoing technical problems according to the technical solutions of this application in detail by using examples. The described embodiments may be combined with each other. For the same or similar concepts or processes, details may not be described repeatedly in some embodiments. The following describes the embodiments of this application in detail with reference to the accompanying drawings.

Corresponding to an application scenario of the method and the method provided in the embodiments of this application, an embodiment of this application further provides a human body video coding apparatus. FIG. 6 is a structural block diagram of a human body video coding apparatus according to an embodiment of this application. The apparatus may include:
a first determining module 62, configured to input a frame in a to-be-coded human body video into a pre-trained 3D human body model OSX, to obtain a first human body semantic set, where the first human body semantic set is used for simplifying description of a human body signal in the to-be-coded human body video;
a second determining module 64, configured to determine a second human body semantic set from the first human body semantic set, where the second human body semantic set is used for describing a motion-related signal in the human body signal, to interact with the human body signal at a decoder side by configuring a value of a human body semantic in the second human body semantic set;
a compression module 66, configured to compress the second human body semantic set to obtain a first coded bit stream, and compress a key reference frame in the to-be-coded human body video to obtain a second coded bit stream; and
a third determining module 68, configured to determine the first coded bit stream and the second coded bit stream as a target coding result of the to-be-coded human body video.

By using the apparatus shown in FIG. 6, the frame in the to-be-coded human body video is inputted into the pre-trained 3D human body model OSX, to obtain the first human body semantic set, where the first human body semantic set is used for simplifying the description of the human body signal in the to-be-coded human body video; the second human body semantic set is determined from the first human body semantic set, where the second human body semantic set is used for describing the motion-related signal in the human body signal, to interact with the human body signal at the decoder side by configuring the value of the human body semantic in the second human body semantic set; the second human body semantic set is compressed to obtain the first coded bit stream, and the key reference frame in the to-be-coded human body video is compressed to obtain the second coded bit stream; and the first coded bit stream and the second coded bit stream are determined as the target coding result of the to-be-coded human body video. In other words, in the embodiments of this application, the human body signal is represented by using the human body semantic outputted by the pre-trained 3D human body model OSX, and the outputted human body semantic is optimized, to generate a compact human body semantic. In addition, because the compact human body semantic has a clear physical meaning and is configurable at the decoder side, a finally generated compact and configurable human body semantic codes the human body signal, which improves compression efficiency and enhances interactivity, thereby resolving technical problems such as that compression efficiency of a coded bit stream in the related technology is to be improved, and an interaction function of video communication is limited because a current compressed bit stream does not support interaction with an original human body signal.

In an example implementation, the second determining module 64 includes: a first determining unit, configured to: determine, when the to-be-coded human body video is a human body video formed by human body frames of a same sequence, a human body signal shared by the human body frames of the same sequence and a human body semantic corresponding to the shared human body signal in the first human body semantic set, to obtain a first target human body semantic; a second determining unit, configured to determine a human body semantic unrelated to motion in the first human body semantic set, to obtain a second target human body semantic; and a third determining unit, configured to filter out the first target human body semantic and the second target human body semantic from the first human body semantic set, to obtain the second human body semantic set.

The compression module 66 includes: a fourth determining unit, configured to perform inter prediction between a human body semantic of a current frame and a human body semantic of a previously reconstructed frame, to obtain a residual generated by the inter prediction; and a fifth determining unit, configured to: compress, based on context-based arithmetic coding, the residual generated by the inter prediction, to obtain the first coded bit stream.

In some implementations, the second human body semantic set includes at least the following human body semantics: a human body pose parameter, a human body translation parameter, a human body rotation parameter, and a human body location parameter, where the human body semantic is multi-dimensional, and dimensions of different human body semantics are determined by using a transmission bandwidth.

For functions of modules in the apparatuses in the embodiments of this application, reference may be made to corresponding descriptions in the foregoing method, and corresponding beneficial effects are provided. Details are not described herein again.

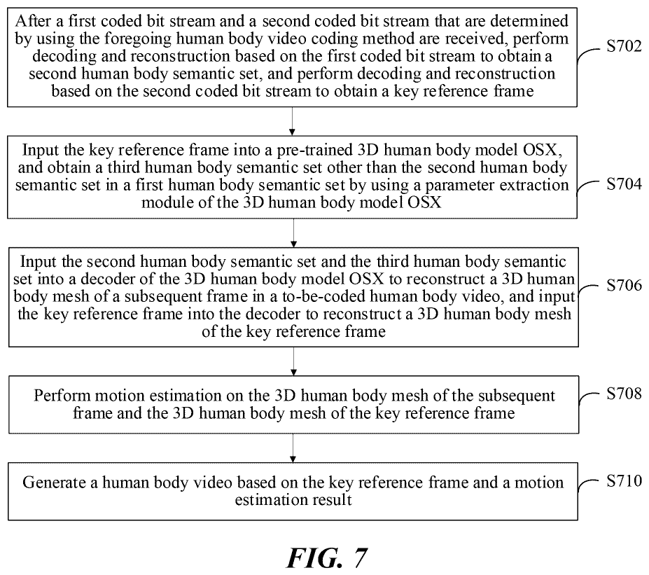

Corresponding to an application scenario of the method and the method provided in the embodiments of this application, an embodiment of this application further provides a human body video decoding method. FIG. 7 shows a human body video decoding method according to an embodiment of this application. The method includes the following steps.

S702. After a first coded bit stream and a second coded bit stream that are determined by using the foregoing human body video coding method are received, perform decoding and reconstruction based on the first coded bit stream to obtain a second human body semantic set, and perform decoding and reconstruction based on the second coded bit stream to obtain a key reference frame.

In some implementations, a manner of performing decoding and reconstruction based on the first coded bit stream to obtain the second human body semantic set may be performing operations such as entropy decoding and compensation on the first coded bit stream to obtain the second human body semantic set. A manner of performing decoding and reconstruction based on the second coded bit stream to obtain the key reference frame may be inputting the second coded bit stream to a VVC codec for decoding to obtain the key reference frame.

S704. Input the key reference frame into a pre-trained 3D human body model OSX, and obtain a third human body semantic set other than the second human body semantic set in a first human body semantic set by using a parameter extraction module of the 3D human body model OSX.

For example, it is assumed that the first human body semantic set includes: 3D independent body joints δ_{body∈}R^{21×3}, a body shape δ_{shape∈}R¹⁰, 3D global translation δ_{trans∈}R³, 3D global rotation δ_{rot∈}R³, and a positioning bounding box δ_{loc∈}R³. If the second human body semantic set is δₛₑₘ={δₚₒₛₑ,δₜᵣₐₙₛ,δᵣₒₜ,δ_{loc}}, the third human body semantic set may include: the body shape δₛₕₐₚₑ and the first 42 dimensions of δ_{body}.

S706. Input the second human body semantic set and the third human body semantic set into a decoder of the 3D human body model OSX to reconstruct a 3D human body mesh of a subsequent frame in a to-be-coded human body video, and input the key reference frame into the decoder to reconstruct a 3D human body mesh of the key reference frame.

S708. Perform motion estimation on the 3D human body mesh of the subsequent frame and the 3D human body mesh of the key reference frame.

S710. Generate a human body video based on the key reference frame and a motion estimation result.

Through the foregoing step S702 to step S710, decoding and reconstruction are performed based on the first coded bit stream to obtain the second human body semantic set, and decoding and reconstruction are performed based on the second coded bit stream to obtain the key reference frame; the key reference frame is inputted into the pre-trained 3D human body model OSX, and the third human body semantic set other than the second human body semantic set in the first human body semantic set is obtained by using the parameter extraction module of the 3D human body model OSX; the second human body semantic set and the third human body semantic set are inputted into the decoder of the 3D human body model OSX to reconstruct the 3D human body mesh of the subsequent frame in the to-be-coded human body video, and the key reference frame is inputted into the decoder to reconstruct the 3D human body mesh of the key reference frame; motion estimation is performed on the 3D human body mesh of the subsequent frame and the 3D human body mesh of the key reference frame; and the human body video is generated based on the key reference frame and the motion estimation result. In other words, in the embodiments of this application, semantic hierarchy representations are provided in the coded bit stream, and these semantically meaningful representations are explicitly evolved into high-dimensional mesh representations with the help of the 3D human body model, thereby promoting dynamic perception, and further improving quality of a decoded video that needs to be reconstructed.

In some implementations, step S706 may include the following steps. S7061. Use, by using a generation function OSX(·) in the decoder, the second human body semantic set and the third human body semantic set as an input of the generation function, to obtain a generation result. S7062. Determine the 3D human body mesh of the subsequent frame by using the generation result.

Because the generation function OSX(·) may combine the semantic information to predict or generate some structures, in the embodiments of this application, the generation function OSX(·) may be used to efficiently convert multi-frame human body semantics into a detailed 3D human body mesh model, thereby further improving quality of human body mesh reconstruction.

For example, it is assumed that a human body semantic of a reconstructed subsequent frame I (1≤l≤n,l_{∈}Z) is

$${\hat{δ}}_{sem}^{{I}_{l}} ,$$

a human body semantic of a reconstructed key reference frame \hat{K} is

$${δ}_{shape}^{\hat{K}} ,$$

and the first 42 dimensions are

$${δ}_{body}^{\hat{K}} ,$$

a 3D human body mesh Mₗ_{₁} of the subsequent frame may be determined by using the following formula:

$${M}_{{l}_{ι}} = OSX ( {\hat{δ}}_{sem}^{{I}_{l}} , {δ}_{shape}^{\hat{K}} , {δ}_{body}^{\hat{K}} ) \qquad ( Formula 1 )$$

in the embodiments of this application, the 3D human body mesh M_{\ddot{k}} of the reconstructed key reference frame may be directly generated by using the OSX model.

In some implementations, S708 may include: S7081. Convert the 3D human body mesh of the subsequent frame to obtain a 2D human body mesh of the subsequent frame, and convert the 3D human body mesh of the key reference frame to obtain a 2D human body mesh of the key reference frame. In this step, the 3D human body mesh may be converted into the 2D human body mesh for ease of motion estimation.

S7082. Convert the 2D human body mesh of the subsequent frame and the 2D human body mesh of the key reference frame into a pixel-level dense motion field by using a spatially-adaptive normalization SPADE network, where the dense motion field includes at least a dense motion flow and an occlusion map.

In some implementations, a spatially-adaptive normalization (SPADE) mechanism (e.g., SPADE(·)) is used as a backbone network for predicting these motion fields. This is because the SPADE network can better learn inverse mapping from the 2D human body mesh of the subsequent frame and the 2D human body mesh of the key reference frame. Therefore, the dense motion flow and the occlusion map may be used as guidance for signal reconstruction.

For example, it is assumed that the 2D human body mesh of the subsequent frame is

$${M}_{{I}_{l}}^{2 D}$$

and the 2D human body mesh of the key reference frame is

$${M}_{\hat{K}}^{2 D} ,$$

a dense motion flow

$${Γ}_{flow}^{{I}_{l}}$$

and an occlusion map

$${Λ}_{occlusion}^{{I}_{l}}$$

may be determined in the following manner:

$${Γ}_{flow}^{{I}_{l}} = {P}_{1} ( SPADE ( \hat{K} , {M}_{\hat{K}}^{2 D} , {M}_{{I}_{l}}^{2 D} ) ) \qquad ( Formula 2 )$$

$${Λ}_{occlusion}^{{I}_{l}} = {P}_{2} ( SPADE ( \hat{K} , {M}_{\hat{K}}^{2 D} , {M}_{{I}_{l}}^{2 D} ) ) \qquad ( Formula 3 )$$

where P1(·) and P2(·) respectively represent two different predicted outputs.

Considering a strong reasoning capability of a deep generative model, e.g., a deep generative network, realistic signal reconstruction can be well promoted in a generative compression paradigm. In some implementations, an example GAN architecture is used in the embodiments of this application. In this GAN architecture, S710 may include: S7101. Warp the key reference frame and the dense motion flow to obtain a warped result. S7102. Perform a Hadamard product on the occlusion map and the warped result to generate the human body video.

In other words, in the embodiments of this application, a feature warping strategy is used, and a decoded key reference frame K and a dense motion flow

$${Γ}_{flow}^{{I}_{l}}$$

in a feature-level domain are distorted. Subsequently, the occlusion map

$${Λ}_{occlusion}^{{I}_{l}}$$

is used to indicate a feature map region with corresponding confidence, which can improve reconstruction fidelity. An entire process may be described by using the following formula:

$${\hat{I}}_{l} = {Λ}_{occlusion}^{{I}_{l}} ⊙ {f}_{w} ( \hat{K} , {Γ}_{flow}^{{I}_{l}} ) \qquad ( Formula 4 )$$

where and ⊙ respectively represent a backward warping operation and a Hadamard product.

In some implementations, in the embodiments of this application, a generation result Î₁ may be further inputted into a discriminator module, to approximate a distribution of an original signal.

The following describes the technical solutions of this application and how to resolve the foregoing technical problems according to the technical solutions of this application in detail by using specific embodiments. The listed several specific embodiments may be combined with each other. For the same or similar concepts or processes, details may not be described repeatedly in some embodiments. The following describes the embodiments of this application in detail with reference to the accompanying drawings.

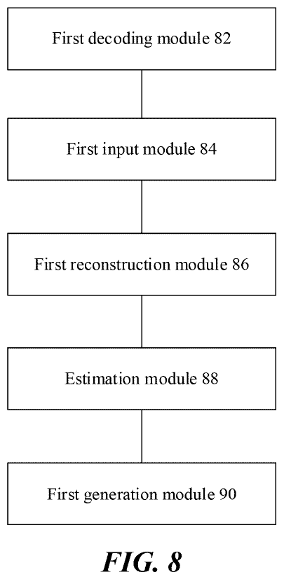

Corresponding to an application scenario of the method and the method provided in the embodiments of this application, an embodiment of this application further provides a human body video decoding apparatus. FIG. 8 is a structural block diagram of a human body video decoding apparatus according to an embodiment of this application. The apparatus may include:
a first decoding module 82, configured to: after a first coded bit stream and a second coded bit stream that are determined by using a human body video coding method are received, perform decoding and reconstruction based on the first coded bit stream to obtain a second human body semantic set, and perform decoding and reconstruction based on the second coded bit stream to obtain a key reference frame;
a first input module 84, configured to input the key reference frame into a pre-trained 3D human body model OSX, and obtain a third human body semantic set other than the second human body semantic set in a first human body semantic set by using a parameter extraction module of the 3D human body model OSX;
a first reconstruction module 86, configured to input the second human body semantic set and the third human body semantic set into a decoder of the 3D human body model OSX, to reconstruct a 3D human body mesh of a subsequent frame in a to-be-coded human body video, and input the key reference frame into the decoder, to reconstruct a 3D human body mesh of the key reference frame;
an estimation module 88, configured to perform motion estimation on the 3D human body mesh of the subsequent frame and the 3D human body mesh of the key reference frame; and
a first generation module 90, configured to generate a human body video based on the key reference frame and a motion estimation result.

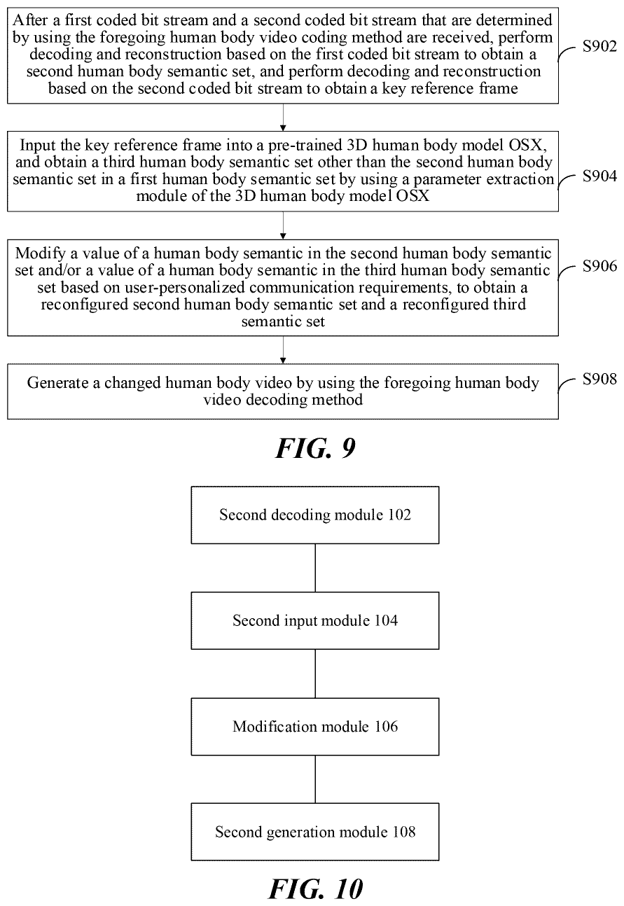

Through the apparatus shown in FIG. 9, decoding and reconstruction are performed based on the first coded bit stream to obtain the second human body semantic set, and decoding and reconstruction are performed based on the second coded bit stream to obtain the key reference frame; the key reference frame is inputted into the pre-trained 3D human body model OSX, and the third human body semantic set other than the second human body semantic set in the first human body semantic set is obtained by using the parameter extraction module of the 3D human body model OSX; the second human body semantic set and the third human body semantic set are inputted into the decoder of the 3D human body model OSX, to reconstruct the 3D human body mesh of the subsequent frame in the to-be-coded human body video, and the key reference frame is inputted into the decoder, to reconstruct the 3D human body mesh of the key reference frame; motion estimation is performed on the 3D human body mesh of the subsequent frame and the 3D human body mesh of the key reference frame; and the human body video is generated based on the key reference frame and the motion estimation result. In other words, in the embodiments of this application, semantic hierarchy representations are provided in the coded bit stream, and these semantically meaningful representations are explicitly evolved into high-dimensional mesh representations with the help of the 3D human body model, thereby promoting dynamic perception, and further improving quality of a decoded video that needs to be reconstructed.

In some implementations, the first reconstruction module 86 includes: an input unit, configured to use, by using a generation function OSX(·) in the decoder, the second human body semantic set and the third human body semantic set as an input of the generation function, to obtain a generation result; and a reconstruction unit 88, configured to determine the 3D human body mesh of the subsequent frame by using the generation result.

The estimation module 88 includes: a first processing unit, configured to convert the 3D human body mesh of the subsequent frame, to obtain a 2D human body mesh of the subsequent frame, and convert the 3D human body mesh of the key reference frame, to obtain a 2D human body mesh of the key reference frame; and a conversion unit, configured to convert the 2D human body mesh of the subsequent frame and the 2D human body mesh of the key reference frame into a pixel-level dense motion field by using a spatially-adaptive normalization SPADE network, where the dense motion field includes at least a dense motion flow and an occlusion map.

The first generation module 90 includes: a second processing unit, configured to warp the key reference frame and the dense motion flow, to obtain a warped result; and a generation unit, configured to perform a Hadamard product on the occlusion map and the warped result, to generate the human body video.

For functions of modules in the apparatuses in the embodiments of this application, reference may be made to corresponding descriptions in the foregoing method, and corresponding beneficial effects are provided. Details are not described herein again.

Corresponding to an application scenario of the method and the method provided in the embodiments of this application, an embodiment of this application further provides a human body video communication method. FIG. 9 shows a human body video communication method according to an embodiment of this application. The method includes:

S902. Perform decoding and reconstruction based on a first coded bit stream after the first coded bit stream and the second coded bit stream that are determined by using the foregoing human body video coding method are received, to obtain the second human body semantic set, and perform decoding and reconstruction based on the second coded bit stream, to obtain the key reference frame.

S904. Input the key reference frame into a pre-trained 3D human body model OSX, and obtain a third human body semantic set other than the second human body semantic set in a first human body semantic set by using a parameter extraction module of the 3D human body model OSX.

In some implementations, for implementation details of step S902 and step S904, reference may be made to the foregoing related descriptions, and details are not described herein again.

S906. Modify a value of a human body semantic in the second human body semantic set and/or a value of a human body semantic in the third human body semantic set based on user-personalized communication requirements, to obtain a reconfigured second human body semantic set and a reconfigured third semantic set.

In some implementations, the user-personalized communication requirements may be editing requirements of a user for an original human body signal, for example, a body pose of the original human body signal is modified from A to B, a head pose of the original human body signal is modified from A to B, and a camera location of the original human body signal is modified from A to B. Because parameters to be modified of these communication requirements all have clear human body semantics, related human body semantics may be independently controlled, thereby achieving immersive interaction and personalized reconstruction.

For example, it is assumed that in a video call scenario, the user intends to move an entire shape of the user in a virtual environment, for example, walk forward or walk backward, the user may modify a human body translation parameter in the second human body semantic set, e.g., a value of 3D global translation δ_{trans∈}R³. For another example, if the user intends to let himself/herself make an exaggerated pose in the virtual environment, the user may modify a human body pose parameter in the second human body semantic set, e.g., a value of δₚₒₛₑ. For another example, if the user intends to make a virtual character be taller, shorter, thinner, or the like in the virtual environment, the user may modify a body shape parameter in the third human body semantic set, e.g., a value of

$${δ}_{shape}^{\hat{K}} .$$

S908. Generate a changed human body video by using the foregoing human body video decoding method.

Through the foregoing step S902 to step S906, after the first coded bit stream and the second coded bit stream that are determined by using the foregoing human body video coding method are received, decoding and reconstruction are performed based on the first coded bit stream to obtain the second human body semantic set, and decoding and reconstruction are performed based on the second coded bit stream to obtain the key reference frame; the key reference frame is inputted into the pre-trained 3D human body model OSX, and the third human body semantic set other than the second human body semantic set in the first human body semantic set is obtained by using the parameter extraction module of the 3D human body model OSX; the value of the human body semantic in the second human body semantic set and/or the value of the human body semantic in the third human body semantic set is modified based on user-personalized communication requirements, to obtain the reconfigured second human body semantic set and the reconfigured third semantic set; and the changed human body video is generated by using the foregoing human body video decoding method. In other words, in the embodiments of this application, reconstruction of a 3D human body mesh may be flexibly edited by modifying different semantic hierarchy representations. For example, values of an angle and a displacement are changed, so that a head pose and a body pose of the 3D mesh are changed to implement a personalized representation, thereby implementing interactive human body video communication.

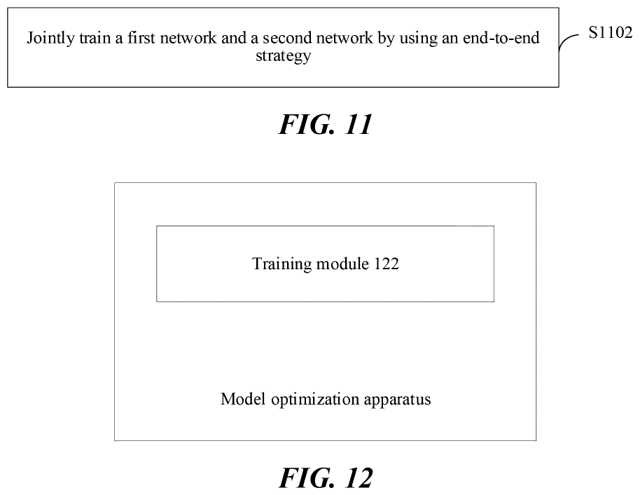

Corresponding to an application scenario of the method and the method provided in the embodiments of this application, an embodiment of this application further provides a human body video communication apparatus. FIG. 10 is a structural block diagram of a human body video communication apparatus according to an embodiment of this application. The apparatus may include:
a second decoding module 102, configured to: after a first coded bit stream and a second coded bit stream that are determined by using the foregoing human body video coding method are received, perform decoding and reconstruction based on the first coded bit stream to obtain a second human body semantic set, and perform decoding and reconstruction based on the second coded bit stream to obtain a key reference frame;
a second input module 104, configured to input the key reference frame into a pre-trained 3D human body model OSX, and obtain a third human body semantic set other than the second human body semantic set in a first human body semantic set by using a parameter extraction module of the 3D human body model OSX;
a modification module 106, configured to modify a value of a human body semantic in the second human body semantic set and/or a value of a human body semantic in the third human body semantic set based on user-personalized communication requirements, to obtain a reconfigured second human body semantic set and a reconfigured third semantic set; and
a second generation module 108, configured to generate a changed human body video by using the foregoing human body video decoding method.

Through the apparatus shown in FIG. 10, after the first coded bit stream and the second coded bit stream that are determined by using the foregoing human body video coding method are received, decoding and reconstruction are performed based on the first coded bit stream to obtain the second human body semantic set, and decoding and reconstruction are performed based on the second coded bit stream to obtain the key reference frame; the key reference frame is inputted into the pre-trained 3D human body model OSX, and the third human body semantic set other than the second human body semantic set in the first human body semantic set is obtained by using the parameter extraction module of the 3D human body model OSX; the value of the human body semantic in the second human body semantic set and/or the value of the human body semantic in the third human body semantic set is modified based on user-personalized communication requirements, to obtain the reconfigured second human body semantic set and the reconfigured third semantic set; and the changed human body video is generated by using the foregoing human body video decoding method. In other words, in the embodiments of this application, reconstruction of a 3D human body mesh may be flexibly edited by modifying different semantic hierarchy representations. For example, values of an angle and a displacement are changed, so that a head pose and a body pose of the 3D mesh are changed to implement a personalized representation, thereby implementing interactive human body video communication.

For functions of modules in the apparatuses in the embodiments of this application, reference may be made to corresponding descriptions in the foregoing method, and corresponding beneficial effects are provided. Details are not described herein again.

Corresponding to an application scenario of the method and the method provided in the embodiments of this application, an embodiment of this application further provides a model optimization method. FIG. 11 shows a model optimization method according to an embodiment of this application. The model is disposed at a decoder side, the model includes a first network and a second network, and the first network and the second network are used for implementing motion estimation and human body video generation during decoding of the foregoing human body video. The method includes:

S1102. Jointly train the first network and the second network by using an end-to-end strategy.

In some implementations, in the embodiments of this application, the first network may be an SPADE network, and the second network may be a GAN network.

Through step S1102, the first network and the second network are jointly trained by using the end-to-end strategy, so that the trained first network may improve efficiency of mesh-based dense motion estimation, thereby promoting dynamic perception. The trained second network may provide generation efficiency of a human body frame, thereby improving quality of a decoded video.

In a possible implementation, S1102 may include the following steps:

S11021. Determine a training loss, where the training loss is a loss determined by weighting a perceptual loss and an adversarial loss by using a preset weight.

In some implementations, in the embodiments of this application, the preset weight includes a first weight and a second weight, and the first weight is greater than the second weight.

For example, it is assumed that the perceptual loss is [symbol] ₚₑᵣ, the adversarial loss is [symbol] _{adv}, the first weight is λₚₑᵣ, and the second weight is λ_{adv}, a total training loss [symbol] ₜₒₜₐₗ is determined by using the following formula:

$${ℒ}_{total} = {λ}_{per} {ℒ}_{per} + {λ}_{adv} {ℒ}_{adv} \qquad ( Formula 5 )$$

In some implementations, λₚₑᵣ and λ_{adv} may be respectively set to 100 and 1. In the embodiments of this application, values of λₚₑᵣ and λ_{adv} may be randomly set based on different task requirements.

S11022. Optimize the model by using the training loss.

Corresponding to an application scenario of the method and the method provided in the embodiments of this application, an embodiment of this application further provides a model optimization apparatus. FIG. 12 is a structural block diagram of a model optimization apparatus according to an embodiment of this application. The model is disposed at a decoder side, the model includes a first network and a second network, and the first network and the second network are used for implementing motion estimation and human body video generation in the foregoing human body video decoding method. The apparatus includes:
a training module 122, configured to jointly train the first network and the second network by using an end-to-end strategy.

In a possible implementation, the training module 122 is further configured to determine a training loss, where the training loss is a loss determined by weighting a perceptual loss and an adversarial loss by using a preset weight; and optimize the model by using the training loss.

Through the apparatus shown in FIG. 12, the first network and the second network are jointly trained by using the end-to-end strategy, so that the trained first network may improve efficiency of mesh-based dense motion estimation, thereby promoting dynamic perception. The trained second network may provide generation efficiency of a human body frame, thereby improving quality of a decoded video.

For functions of modules in the apparatuses in the embodiments of this application, reference may be made to corresponding descriptions in the foregoing method, and corresponding beneficial effects are provided. Details are not described herein again.

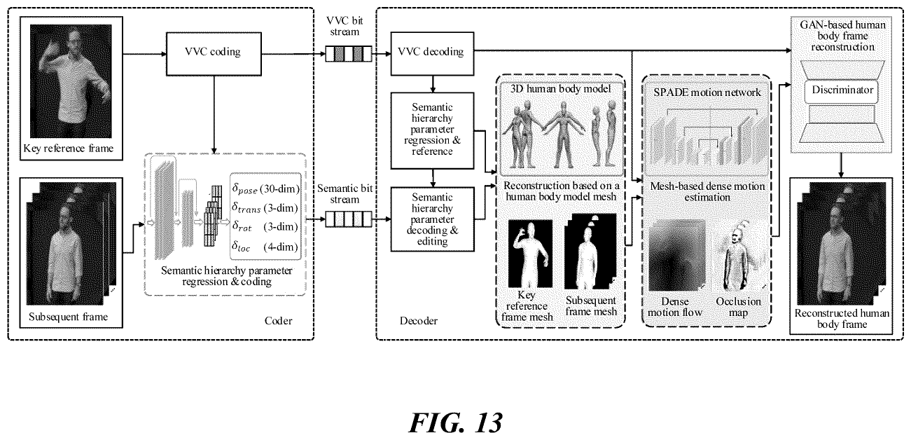

Corresponding to an application scenario of the method and the method provided in the embodiments of this application, an embodiment of this application further provides an interactive human video communication (Interactive Human Video Communication, IHVC) framework. As shown in FIG. 13, the framework may implement human body video communication with a low bandwidth and enhanced interactivity. In particular, at the coder side, the key reference frame representing a human body texture is compressed by using a latest VVC codec, which can provide texture reference for signal synthesis. Subsequently, the subsequent frame is inputted into the pre-trained 3D human body model OSX, and further optimized to generate human body semantics (for example, a 21-dimensional human body pose parameter, a 3-dimensional human body translation parameter, a 3-dimensional human body rotation parameter, and a 4-dimensional human body location parameter) used for representing compactness and interactivity. Dimensions of the human body semantics mentioned herein are only some examples, and values thereof may be determined based on a bandwidth condition. Finally, inter prediction, quantization, and entropy coding are further performed on these highly decoupled human body semantics, to generate a transmission bit stream.

After the coded bit stream is received, the decoder provided in the embodiments of this application performs mesh editing/reconstruction and signal synthesis to implement personalized interaction. First, the key reference frame is decoded by using the VVC codec, and further projected into the pre-trained 3D human body model OSX, to output a human body semantic corresponding to the key reference frame. In addition, a compact semantic of the subsequent frame is obtained through entropy decoding and compensation. Subsequently, the key reference frame and a corresponding semantic of the subsequent frame are inputted into a preset 3D human body model, to reconstruct a human body mesh, thereby generating the pixel-level dense motion field (e.g., the dense motion flow and the occlusion map). In this step, reconstruction of the 3D human body mesh may be flexibly edited by modifying different semantic hierarchy representations, so that a head pose and a body pose of the 3D mesh are changed to implement a personalized representation. Finally, a human body video can be reconstructed with high quality by using the decoded key reference frame and the pixel-level dense motion field and by relying on a strong reasoning capability of the deep generative model.

The IHVC framework provided in the embodiments of this application has several ideal advantages, including compact representation for an ultra-low bit rate and semantically meaningful representation for enhanced interactivity. First, this solution uses prior knowledge of a human body signal, so that 40-dimensional semantic parameters are enough to represent non-linear dynamics and complex motions of the human body signal, thereby promoting human body video communication with an ultra-low bit rate. In addition, these highly decoupled representations have clear semantic meanings in terms of a body pose, a head pose, and a camera location, and can be independently controlled, to implement immersive interaction and personalized reconstruction.

In conclusion, in the embodiments of this application, a human body action in a compressed code stream may be controlled, which may be further applied to human communication with an ultra-low bandwidth and enhanced interactivity in the metaverse, and the virtual uploader of live streaming e-commerce. Due to highly decoupled parameters, the human body mesh of a virtual drive can be redirected only by changing values of the angle and the displacement. Finally, the human body mesh of the virtual drive and a key frame mesh are inputted into a motion estimation module and a frame generation module, to reconstruct a face image with a new pose and location, reflecting adjusted parameters. Embodiments of this application provide a first generative compression framework, which can efficiently code a human body signal with ultra-compact and configurable human body semantics. In this manner, a bit stream having these interactive human body semantics may be conveniently operated, so that motions of the head pose and the body pose of the human body signal are reconstructed at the decoder side, to implement personalized communication. In addition, an embodiment of this application further provides a mesh-based motion estimation solution and a GAN-based human body video generation solution, which can explicitly evolve these semantically meaningful representations into high-dimensional mesh representations with the assistance of the 3D human body model, thereby promoting dynamic perception and improving quality of the decoded video.

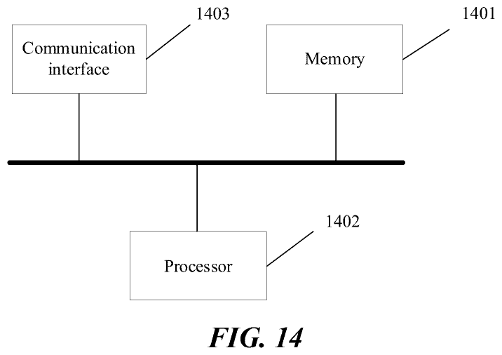

FIG. 14 is a block diagram of an electronic device used to implement embodiments of this application. As shown in FIG. 14, the electronic device includes: a memory 1401 and a processor 1402. The memory 1401 stores a computer program that can run on the processor 1402. When the processor 1402 executes the computer program, the method according to the foregoing embodiments is implemented. A quantity of the memories 1401 and a quantity of the processors 1402 may be one or more.

In an example configuration, the electronic device includes one or more processors 1402, one or more input/output interfaces, one or more network interfaces, and one or more memories 1401. The one or more processors 1402 may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices 1401 may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The electronic device further includes:
a communication interface 1403, configured to communicate with an external device and perform data exchange and transmission.

If the memory 1401, the processor 1402, and the communication interface 1403 are independently implemented, the memory 1401, the processor 1402, and the communication interface 1403 may be connected to each other through a bus and complete communication with each other. The bus may be an industry standard architecture (Industry Standard Architecture, ISA) bus, a peripheral component interconnect (Peripheral Component Interconnect, PCI) bus, an extended industry standard architecture (Extended Industry Standard Architecture, EISA) bus, or the like. The bus may be classified into an address bus, a data bus, a control bus, and the like. For ease of representation, only one bold line is used in FIG. 14 for representation, but this does not mean that there is only one bus or only one type of bus.

In some implementations, in some implementations, if the memory 1401, the processor 1402, and the communication interface 1403 are integrated on one chip, the memory 1401, the processor 1402, and the communication interface 1403 can communicate with each other through an internal interface.

An embodiment of this application provides a computer-readable storage medium, storing a computer program, the program, when executed by a processor, implementing the method provided in the embodiments of this application.

An embodiment of this application further provides a chip, including a processor, configured to invoke instructions from a memory and run the instructions stored in the memory, to enable a communication device in which a chip is installed to perform the method provided in the embodiments of this application.

An embodiment of this application further provides a chip, including: an input interface, an output interface, a processor, and a memory. The input interface, the output interface, the processor, and the memory are connected to each other through an internal connection path, the processor is configured to execute code in the memory, and when the code is executed, the processor is configured to perform the method provided in the embodiments of this application.

It should be understood that, the processor may be a central processing unit (Central Processing Unit, CPU), and may further be another general-purpose processor, a digital signal processor (Digital Signal Processor, DSP), an application specific integrated circuit (Application Specific Integrated Circuit, ASIC), a field programmable gate array (Field Programmable Gate Array, FPGA), or another programmable logic device, a discrete gate or a transistor logic device, a discrete hardware component, or the like. The general-purpose processor may be a microprocessor, or may be any processor, or the like. It should be noted that the processor may be a processor supporting an advanced RISC machines (Advanced RISC Machines, ARM) architecture.

Further, in some implementations, the memory may include a read-only memory and a random access memory. The memory may be a volatile memory or a non-volatile memory, or may include both a volatile memory and a non-volatile memory. The non-volatile memory may include a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may include a random access memory (Random Access Memory, RAM) that is used as an external cache. Through example but not limitative description, many forms of RAM are available. For example, a static random access memory (static RAM, SRAM), a dynamic random access memory (dynamic random access memory, DRAM), a synchronous dynamic random access memory (synchronous DRAM, SDRAM), a double data rate synchronous dynamic random access memory (double data rate SDRAM, DDRSDRAM), an enhanced synchronous dynamic random access memory (enhanced SDRAM, ESDRAM), a synch link dynamic random access memory (synch link DRAM, SLDRAM), and a direct rambus random access memory (direct rambus RAM, DRRAM).

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, all or some of the procedures or functions according to the embodiments of this application are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium.

In the descriptions of this specification, a description of a reference term such as “an embodiment”, “some embodiments”, “an example”, “a specific example”, or “some examples” means that a specific feature, structure, material, or characteristic that is described with reference to the embodiment or the example is included in at least one embodiment or example of this application. In addition, the described example feature, structure, material, or characteristic may be combined in a proper manner in any one or more embodiments or examples. In addition, a person skilled in the art may combine different embodiments or examples and features of the different embodiments or examples that are described in this specification in a case of no contradiction.

In addition, terms “first” and “second” are only used for the purpose of description, and shall not be construed as indicating or implying relative importance or implicitly indicating a quantity of technical features indicated. Therefore, features defined with “first” and “second” may explicitly or implicitly include at least one of the features. In the descriptions of this application, “a plurality of” means two or more, unless otherwise definitely and for example limited.

Any process or method described in the flowcharts or described herein in another manner may be understood as indicating a module, a segment, or a part including code of one or more executable instructions for implementing a specific logical function or process step. In addition, the scope of preferred embodiments of this application includes other implementations which do not follow the order shown or discussed, including executing, according to involved functions, the functions basically simultaneously or in a reverse order.

Logic and/or steps described in the flowcharts or described herein in another manner, for example, may be considered as a sequenced list of executable instructions used for implementing logical functions, and may be for example implemented in any computer-readable medium, to be used by an instruction execution system, apparatus, or device (for example, a computer-based system, a system including a processor, or another system that can obtain instructions from an instruction execution system, apparatus, or device and execute the instructions), or to be used in combination with such an instruction execution system, apparatus, or device.

It should be understood that parts of this application may be implemented by using hardware, software, firmware, or combinations thereof. In the foregoing implementations, a plurality of steps or methods are implemented by software or firmware which is stored in a memory and executed by a proper instruction execution system. All or some of the steps of the method embodiments may be implemented by a program instructing relevant hardware. The program may be stored in a computer-readable storage medium. When the program is run, one or a combination of the steps of the method embodiments are performed.

In addition, functional units in the embodiments of this application may be integrated into one processing module, each of the units may exist alone physically, or two or more units are integrated into one module. The foregoing integrated module may be implemented in a form of hardware, or may be implemented in a form of a software functional module. When the integrated module is implemented in the form of a software functional module and sold or used as an independent product, the integrated module may also be stored in a computer-readable storage medium. The storage medium may be a read-only memory, a magnetic disk, or an optical disc.

The foregoing descriptions are merely example implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
inputting a frame in a human body video into a 3D human body model, to obtain a first human body semantic set, the first human body semantic set representing a simplified description of a human body signal in the human body video;
determining a second human body semantic set from the first human body semantic set, the second human body semantic set representing a description of a motion-related signal in the human body signal, the second human body semantic set including a first portion of human body semantics of the first human body semantic set less than all human body semantics of the first human body semantic set;
compressing the second human body semantic set to obtain a first coded bit stream;
compressing a key reference frame in the human body video to obtain a second coded bit stream; and
determining the first coded bit stream and the second coded bit stream as a target coding result of the human body video.

2. The method according to claim 1, wherein the human body video includes human body frames of a same sequence, and the determining the second human body semantic set from the first human body semantic set includes:
determining a human body signal shared by the human body frames of the same sequence and a first human body semantic corresponding to the shared human body signal in the first human body semantic set, to obtain a first target human body semantic;
determining a second human body semantic unrelated to motion in the first human body semantic set, to obtain a second target human body semantic; and
removing the first target human body semantic and the second target human body semantic from the first human body semantic set, to obtain the second human body semantic set.

3. The method according to claim 1, wherein the compressing the second human body semantic set to obtain the first coded bit stream includes:
performing inter prediction between a human body semantic of a current frame and a human body semantic of a previously reconstructed frame, to obtain a residual; and
compressing, based on context-based arithmetic coding, the residual, to obtain the first coded bit stream.

4. The method according to claim 1, wherein the determining the second human body semantic set includes interacting with the human body signal at a decoder side by configuring a value of a human body semantic in the second human body semantic set.

5. The method according to claim 1, wherein the compressing the second human body semantic set and the compressing the key reference frame use different types of compression schemes from one another.

6. The method according to claim 5, wherein the compressing the key reference frame includes compressing the key reference frame using VVC codec.

7. The method according to claim 5, wherein the compressing the second human body semantic set includes one or more of inter-predicting, quantizing, or entropy coding.

8. The method according to claim 1, wherein the first human body semantic set is obtained through a neural-network based parameter regressor.

9. The method according to claim 1, wherein the second human body semantic set includes one or more of following human body semantics:
a human body pose parameter,
a human body translation parameter,
a human body rotation parameter, or
a human body location parameter,
wherein each of the human body semantics is multi-dimensional, and dimensions of different human body semantics are determined by using a transmission bandwidth.

10. A method, comprising:
receiving a first coded bit stream and a second coded bit stream;
decoding, based on the first coded bit stream, to obtain a first human body semantic set;
decoding, based on the second coded bit stream, to obtain a key reference frame;
obtaining a second human body semantic set different from the first human body semantic set based on the key reference frame;
reconstructing, based on the first human body semantic set and the second human body semantic set, a 3D human body mesh of a frame;
reconstructing, based on the key reference frame, a 3D human body mesh of the key reference frame;
performing motion estimation on the 3D human body mesh of the frame and the 3D human body mesh of the key reference frame; and
generating a human body video based on the key reference frame and a result of the motion estimation.

11. The method according to claim 13, wherein the reconstructing, based on the first human body semantic set and the second human body semantic set, the 3D human body mesh of the frame includes:
inputting the first human body semantic set and the second human body semantic set into a generation function of a 3D human body model, to obtain a generation result; and
determining the 3D human body mesh of the frame by using the generation result.

12. The method according to claim 10, wherein the performing motion estimation on the 3D human body mesh of the frame and the 3D human body mesh of the key reference frame includes:
converting the 3D human body mesh of the frame into a 2D human body mesh of the frame;
converting the 3D human body mesh of the key reference frame into a 2D human body mesh of the key reference frame; and
converting the 2D human body mesh of the frame and the 2D human body mesh of the key reference frame into a pixel-level dense motion field by using a spatially-adaptive normalization network, wherein the dense motion field includes a dense motion flow and an occlusion map.

13. The method according to claim 12, wherein the generating the human body video based on the key reference frame and the result of the motion estimation includes:
warping the key reference frame and the dense motion flow to obtain a warped result; and
performing a Hadamard product on the occlusion map and the warped result to generate the human body video.

14. The method according to claim 13, wherein the decoding the first coded bit stream and the decoding the second coded bit stream use different types of decoding schemes from one another.

15. The method according to claim 14, wherein the decoding the first coded bit stream includes entropy decoding and compensation.

16. The method according to claim 14, wherein the decoding the second coded bit stream includes decoding the second coded bit stream using VVC codec.

17. The method according to claim 10, wherein the reconstructing, based on the first human body semantic set and the second human body semantic set, the 3D human body mesh of the frame, includes adjusting a human body semantic of one or more of the first human body semantic set or the second human body semantic set.

18. A method for storing a bitstream, comprising:
generating one or more bitstreams of a human body video through encoding; and
storing the one or more bitstreams generated through the encoding in a non-transitory computer readable medium,
wherein the encoding includes:
inputting a frame in the human body video into a 3D human body model, to obtain a first human body semantic set, the first human body semantic set representing a simplified description of a human body signal in the human body video;
determining a second human body semantic set from the first human body semantic set, the second human body semantic set representing a description of a motion-related signal in the human body signal, the second human body semantic set including a first portion of human body semantics of the first human body semantic set less than all human body semantics of the first human body semantic set;
compressing the second human body semantic set to obtain a first coded bit stream;
compressing a key reference frame in the human body video to obtain a second coded bit stream; and
determining the first coded bit stream and the second coded bit stream as a target coding result of the human body video.

19. The method according to claim 18, wherein the human body video includes human body frames of a same sequence, and the determining the second human body semantic set from the first human body semantic set includes:
determining a human body signal shared by the human body frames of the same sequence and a first human body semantic corresponding to the shared human body signal in the first human body semantic set, to obtain a first target human body semantic;
determining a second human body semantic unrelated to motion in the first human body semantic set, to obtain a second target human body semantic; and
removing the first target human body semantic and the second target human body semantic from the first human body semantic set, to obtain the second human body semantic set.

20. The method according to claim 18, wherein the compressing the key reference frame includes compressing the key reference frame using VVC codec, and the compressing the second human body semantic set includes one or more of inter-predicting, quantizing, or entropy coding.
